(19) United States
(12) Patent Application Publication
(10) Pub. No.: US 2026/0281118 A1
(43) Pub. Date: Sep. 17, 2026

(54) SECURITY MANAGEMENT AND CONTROL METHOD FOR CLOUD DESKTOP, AND DEVICE, STORAGE MEDIUM AND SYSTEM

(71) Applicant: CLOUD INTELLIGENCE ASSETS HOLDING (SINGAPORE) PRIVATE LIMITED, Singapore (SG)

(72) Inventors: Xiantao ZHANG, Hangzhou, Zhejiang (CN); Jinkui REN, Shanghai (CN); Dong XU, Hangzhou, Zhejiang (CN); Bin YANG, Shanghai (CN); Gaosheng XU, Hangzhou, Zhejiang (CN); Xuesen ZANG, Hangzhou, Zhejiang (CN); Xu ZHANG, Shanghai (CN)

(73) Assignee: CLOUD INTELLIGENCE ASSETS HOLDING (SINGAPORE) PRIVATE LIMITED, Singapore (SG)

(21) Appl. No.: 19/165,091

(22) PCT Filed: Mar. 4, 2024
(86) PCT No.: PCT/CN2024/079917

§ 371 Date: Sep. 12, 2025

(30) Foreign Application Priority Data
Mar. 13, 2023 (CN) 202310265932.8

(51) Int. Cl. H04L 9/40

(52) U.S. Cl. CPC H04L 63/102

(57) ABSTRACT

A cloud desktop security management and control method, and a device, a storage medium and a system are provided. The system includes: a management and control server, configured to configure a first cloud desktop and a second cloud desktop for a target user, configure a first security policy for the first cloud desktop, and configure a second security policy for the second cloud desktop; a client, respectively communicatively connected to the first cloud desktop and the second cloud desktop, wherein a display screen corresponding to the client includes a first screen corresponding to the first cloud desktop and a second screen corresponding to the second cloud desktop; and a target cloud desktop, configured to obtain an operation behavior triggered by the target user through a target screen, and respond to the operation behavior according to a security policy corresponding to the target cloud desktop.

### CROSS REFERENCE TO RELATED APPLICATIONS

This disclosure is a National Stage of International Application PCT/CN2024/079917, filed on Mar. 4, 2024, which claims priority to Chinese Patent Application No. 2023102659328, filed with the Chinese National Intellectual Property Administration on Mar. 13, 2023 and entitled “SECURITY MANAGEMENT AND CONTROL METHOD FOR CLOUD DESKTOP, AND DEVICE, STORAGE MEDIUM AND SYSTEM”, the mentioned applications are incorporated herein by reference.

### TECHNICAL FIELD

This disclosure relates to the field of Internet technologies, and in particular, to a cloud desktop security management and control method, a device, a storage medium, and a system.

### BACKGROUND

Considering factors such as data qualification security and reducing production costs, more and more companies are choosing the transformation path of cloudification office, using cloud desktops to efficiently, securely, and flexibly deliver office resources needed by employees, such as printers and other terminal devices.

In the cloudification office scenario, a simple usage mode is as follows: an employee is assigned a cloud desktop, and the employee uses a corresponding host machine (commonly known as a thin client, which is a terminal device having client software corresponding to the cloud desktop installed therein) to access the assigned cloud desktop in the cloud.

In daily office work, to quickly solve problems and produce efficiently, employees inevitably have to use the Internet to search for information, and inevitably transfer data between different office tools and websites. However, employees usually do not fully understand the data risks brought by various network operations, which may cause production data of the enterprise to suffer from network attacks or to be leaked due to careless operations. Therefore, how to enable employees to efficiently complete office work while ensuring the security of enterprise data is an urgent problem to be solved.

### SUMMARY

Embodiments of this disclosure provide a cloud desktop security management and control method, a device, a storage medium, and a system, to achieve efficient office work while ensuring data security.

According to a first aspect, an embodiment of this disclosure provides a cloud desktop security management and control method, applied to a target cloud desktop corresponding to a target user, where the target cloud desktop is one of a first cloud desktop and a second cloud desktop assigned to the target user, the first cloud desktop and the second cloud desktop corresponding to the target user are respectively communicatively connected to a same client of the target user, and a display screen corresponding to the client includes a first screen corresponding to the first cloud desktop and a second screen corresponding to the second cloud desktop, the method including: receiving a security policy corresponding to the target cloud desktop sent by a management and control server, where the first cloud desktop is configured with a first security policy and the second cloud desktop is configured with a second security policy; obtaining an operation behavior triggered by the target user through a target screen, where the target screen is a screen corresponding to the target cloud desktop in the first screen and the second screen; and processing the operation behavior according to the security policy corresponding to the target cloud desktop.

According to a second aspect, an embodiment of this disclosure provides a cloud desktop security management and control apparatus, applied to a target cloud desktop corresponding to a target user, where the target cloud desktop is one of a first cloud desktop and a second cloud desktop assigned to the target user, the first cloud desktop and the second cloud desktop corresponding to the target user are respectively communicatively connected to a same client of the target user, and a display screen corresponding to the client includes a first screen corresponding to the first cloud desktop and a second screen corresponding to the second cloud desktop, the apparatus including: a receiving module, configured to receive a security policy corresponding to the target cloud desktop sent by a management and control server, where the first cloud desktop is configured with a first security policy and the second cloud desktop is configured with a second security policy; an obtaining module, configured to obtain an operation behavior triggered by the target user through a target screen, where the target screen is a screen corresponding to the target cloud desktop in the first screen and the second screen; and a processing module, configured to process the operation behavior according to the security policy corresponding to the target cloud desktop.

According to a third aspect, an embodiment of this disclosure provides an electronic device, including: a memory, a processor, and a communication interface, where the memory has executable codes stored therein, and the executable codes, when executed by the processor, cause the processor to perform the cloud desktop security management and control method according to the first aspect.

According to a fourth aspect, an embodiment of this disclosure provides a non-transitory machine-readable storage medium, having executable codes stored therein, where the executable codes, when executed by a processor of an electronic device, cause the processor to at least implement the cloud desktop security management and control method according to the first aspect.

According to a fifth aspect, an embodiment of this disclosure provides a cloud desktop security management and control method, applied to a client corresponding to a target user, the method including: communicatively connecting to a first cloud desktop and a second cloud desktop corresponding to the target user, where the first cloud desktop is configured with a first security policy, the second cloud desktop is configured with a second security policy, and a display screen corresponding to the client includes a first screen corresponding to the first cloud desktop and a second screen corresponding to the second cloud desktop; and sending an operation behavior triggered by the target user through a target screen to a target cloud desktop corresponding to the target screen, so that the target cloud desktop processes the operation behavior according to a corresponding security policy, where the target cloud desktop is one of the first cloud desktop and the second cloud desktop.

According to a sixth aspect, an embodiment of this disclosure provides a cloud desktop security management and control apparatus, applied to a client corresponding to a target user, the apparatus including: a connection module, configured to communicatively connect to a first cloud desktop and a second cloud desktop corresponding to the target user, where the first cloud desktop is configured with a first security policy, the second cloud desktop is configured with a second security policy, and a display screen corresponding to the client includes a first screen corresponding to the first cloud desktop and a second screen corresponding to the second cloud desktop; and a sending module, configured to send an operation behavior triggered by the target user through a target screen to a target cloud desktop corresponding to the target screen, so that the target cloud desktop processes the operation behavior according to a corresponding security policy, where the target cloud desktop is one of the first cloud desktop and the second cloud desktop.

According to a seventh aspect, an embodiment of this disclosure provides an electronic device, including: a memory, a processor, and a communication interface, where the memory has executable codes stored therein, and the executable codes, when executed by the processor, cause the processor to perform the cloud desktop security management and control method according to the fifth aspect.

According to an eighth aspect, an embodiment of this disclosure provides a non-transitory machine-readable storage medium, having executable codes stored therein, where the executable codes, when executed by a processor of an electronic device, cause the processor to at least implement the cloud desktop security management and control method according to the fifth aspect.

According to a ninth aspect, an embodiment of this disclosure provides a cloud desktop security management and control system, including: a management and control server, configured to configure a first cloud desktop and a second cloud desktop for a target user, configure a first security policy for the first cloud desktop, and configure a second security policy for the second cloud desktop; a client, respectively communicatively connected to the first cloud desktop and the second cloud desktop corresponding to the target user, where a display screen corresponding to the client includes a first screen corresponding to the first cloud desktop and a second screen corresponding to the second cloud desktop; and a target cloud desktop corresponding to the target user, configured to obtain an operation behavior triggered by the target user through a target screen, and process the operation behavior according to a security policy corresponding to the target cloud desktop, where the target cloud desktop includes the first cloud desktop and the second cloud desktop corresponding to the target user, and the target screen is a screen corresponding to the target cloud desktop in the first screen and the second screen.

### BRIEF DESCRIPTION OF DRAWINGS

To describe the technical solutions of the embodiments of this disclosure more clearly, the following briefly introduces the accompanying drawings required for describing the embodiments of this disclosure. Apparently, the accompanying drawings in the following description show some embodiments of this disclosure, and a person of ordinary skill in the art may still derive other drawings from these accompanying drawings without creative efforts.

FIG. 1 is a schematic composition diagram of a cloud desktop security management and control system according to an embodiment of this disclosure.

FIG. 2 is a flowchart of a cloud desktop security management and control method according to an embodiment of this disclosure.

FIG. 3 is a schematic diagram of copying data between different cloud desktops according to an embodiment of this disclosure.

FIG. 4 is a schematic diagram of different cloud desktops accessing each other according to an embodiment of this disclosure.

FIG. 5 is a flowchart of a cloud desktop security management and control method according to an embodiment of this disclosure.

FIG. 6 is a schematic structural diagram of a cloud desktop security management and control apparatus according to an embodiment of this disclosure.

FIG. 7 is a schematic structural diagram of an electronic device according to an embodiment of this disclosure.

FIG. 8 is a schematic structural diagram of a cloud desktop security management and control apparatus according to an embodiment of this disclosure.

FIG. 9 is a schematic structural diagram of an electronic device according to an embodiment of this disclosure.

### DETAILED DESCRIPTION

To make the objectives, technical solutions and advantages of the embodiments of this disclosure clearer, the technical solutions in the embodiments of this disclosure will be described clearly and thoroughly with reference to the accompanying drawings in the embodiments of this disclosure. Apparently, the embodiments described are merely some embodiments, rather than all of the embodiments of this disclosure. All other embodiments obtained by a person of ordinary skill in the art based on the embodiments of this disclosure without making creative efforts shall fall within the protection scope of this disclosure. In addition, the order of the steps in the method embodiments described below is merely an example and is not strictly limiting.

It should be noted that user information (including, but not limited to, user equipment information, user personal information, and the like) and data (including, but not limited to, data for analysis, stored data, displayed data, and the like) involved in the embodiments of this disclosure are information and data that are authorized by a user or that are sufficiently authorized by all parties, related data needs to be collected, used, and processed by complying with related laws and regulations and standards of related countries and regions, and a corresponding operation entry is provided for the user to select to grant or deny authorization.

Cloud desktop is a computing-based cloud desktop service that uses Desktop as a Service (DaaS) to provide users with an easy-to-use, safe, and efficient cloud desktop office system. Cloud desktops run in the cloud. For example, several virtual machines are created in the cloud, and different cloud desktops are deployed on different virtual machines to be assigned to different users for using. Therefore, the cloud desktops may also be referred to as cloud computers. A user uses a thin client or a conventional user terminal (such as a notebook computer, etc.) installed with a client program corresponding to a cloud desktop, to connect to the cloud desktop through a public network or a dedicated line and therefore remotely access the cloud desktop.

Data transmission between the cloud desktop and the client is performed through a streaming transmission protocol.

A cloud desktop security management and control solution provided by the embodiments of this disclosure can be applied to provide cloudification office services for users such as an enterprise, create and assign cloud desktops to different employees in the enterprise by means of software and hardware resources provided by a cloud service provider, and perform on-demand management and control of the use of cloud desktops.

FIG. 1 is a schematic composition diagram of a cloud desktop security management and control system according to an embodiment of this disclosure. As shown in FIG. 1, the system includes: a management and control server 101, configured to configure a first cloud desktop 102 and a second cloud desktop 103 for a target user, configure a first security policy for the first cloud desktop, and configure a second security policy for the second cloud desktop; a client, respectively communicatively connected to the first cloud desktop and the second cloud desktop corresponding to the target user, where a display screen corresponding to the client includes a first screen 104 corresponding to the first cloud desktop and a second screen 105 corresponding to the second cloud desktop; and a target cloud desktop corresponding to the target user, configured to obtain an operation behavior triggered by the target user through a target screen, and process the operation behavior according to a security policy corresponding to the target cloud desktop, where the target cloud desktop includes the first cloud desktop and the second cloud desktop corresponding to the target user, and the target screen is a screen corresponding to the target cloud desktop in the first screen and the second screen.

In fact, the target user may be any user in a target user set. It can be seen that the cloud desktop security management and control system includes a cloud-side subsystem and a user-side subsystem. The cloud-side subsystem includes the management and control server and a cloud desktop set created by the management and control server for the target user set. The user-side subsystem includes clients corresponding to users in the target user set.

In practical applications, the target user set may be a set of employees (e.g., N employees, N>1) in an enterprise. The management and control server creates a corresponding cloud desktop set for the enterprise according to demand information of the enterprise.

In an embodiment of this disclosure, an enterprise may provide a cloud service provider with required resource specification information and the number of employees. The resource specification information includes, for example, the number of CPU cores, memory capacity, and the like. Based on the resource specification information and employee information, the management and control server may create two cloud desktops for each employee.

For example, if the enterprise specifies that a resource specification corresponding to an employee is 4-core CPU and 8G memory, two cloud desktops corresponding to an employee may each occupy 2-core CPU and 4G memory. In this example, the management and control server may create two virtual machines each occupying 2-core CPU and 4G memory, deploy cloud desktops in the two virtual machines, and assign the two cloud desktops to an employee, i.e., establish a correspondence between an identity of the employee and the two cloud desktops, to indicate that the employee is allowed to use the two cloud desktops.

It can be seen that when a target user set corresponding to an enterprise includes N users, the management and control server may create 2N cloud desktops for the target user set, where each user has two cloud desktops. The cloud desktops may form two cloud desktop sets, e.g., a secure desktop set and a non-secure desktop set shown in FIG. 1. The secure desktop set includes one cloud desktop of each of the N users, and the non-secure desktop set includes the other cloud desktop of each of the N users.

In effect, the management and control server may create two isolated local area networks for the target user set: a first local area network and a second local area network. The N cloud desktops included in the secure desktop set are deployed in the first local area network, and the N cloud desktops included in the non-secure desktop set are deployed in the second local area network, i.e., N virtual machines corresponding to the N cloud desktops included in the secure desktop set (one cloud desktop being deployed in each virtual machine) are located in the first local area network, and N virtual machines corresponding to the N cloud desktops included in the non-secure desktop set are located in the second local area network. In practical applications, in an implementation, the local area network may be a virtual private cloud (VPC).

In addition to creating two corresponding cloud desktops for each user in the target user set, the management and control server also delivers different security policies to the cloud desktops in the two different cloud desktop sets through communication connections with the virtual machines where the cloud desktops are respectively located.

In practical applications, employees in an enterprise may have demand to access an external network during daily office work, but some sensitive data in the enterprise also requires data security protection to prevent data leakage. Considering this actual need, two security policies may be set: a first security policy and a second security policy. The first security policy is set for ensuring data security, and aims to provide a secure office environment. The second security policy is set to meet the actual office needs of employees in the enterprise, and aims to provide a relaxed and flexible office environment.

In practical applications, the first security policy and the second security policy may include two types of policies: a network security policy and a copy security policy. The network security policy describes whether a cloud desktop is allowed to access an external network and whether a cloud desktop is allowed to access or be accessed by another cloud desktop in a same desktop set to which the cloud desktop belongs. The copy security policy describes whether data is allowed to be copied between two cloud desktops of the same user.

For the secure desktop set and the non-secure desktop set in FIG. 1, the first security policy may be delivered to the N cloud desktops in the secure desktop set, and the second security policy may be delivered to the N cloud desktops in the non-secure desktop set. In this way, the cloud desktops in the two desktop sets have different security policies, i.e., two cloud desktops corresponding to a user are configured with different security policies.

Since two cloud desktops corresponding to a user have different security policies, operation behaviors of the user on the two cloud desktops are restricted by the security policies configured for the two cloud desktops.

In an implementation, the cloud desktops in the secure desktop set and the cloud desktops in the non-secure desktop set may carry different applications. Applications involving sensitive information in the enterprise may be deployed on the cloud desktops in the secure desktop set, and other common applications may be deployed on the cloud desktops in the non-secure desktop set or on the cloud desktops in the secure desktop set. In other words, two cloud desktops corresponding to a user may be the same or partially the same.

In view of this, the enterprise may notify the management and control server of an application related to sensitive information, and when the management and control server creates cloud desktops, the application related to the sensitive information is deployed on the cloud desktops added to the secure desktop set, and the application related to the sensitive information is not deployed on the cloud desktops added to the non-secure desktop set.

The above introduces a process of creating two cloud desktop sets for the target user set in the cloud and configuring different security policies for the cloud desktops in the two cloud desktop sets.

Correspondingly, on the user side, corresponding clients also need to be provided for users in the target user set. As described in the above example, assuming that the target user set includes N users, one client may be deployed in a terminal device of each user.

For convenience of description, for any target user in the target user set, it is assumed that the target user is assigned a first cloud desktop and a second cloud desktop, the first cloud desktop is configured with a first security policy, and the second cloud desktop is configured with a second security policy. One client corresponding to the two cloud desktops is installed in a terminal device of the target user. It should be noted that in the embodiments of this disclosure, the client establishes a communication connection with each of the two cloud desktops corresponding to the target user, i.e., there are two communication connections, e.g., a first communication connection and a second communication connection shown in FIG. 1. In practical applications, communication protocols corresponding to the two communication connections are each a streaming transmission protocol suitable for video stream transmission between the cloud desktop and the client.

To display pictures of the first cloud desktop and the second cloud desktop on the terminal device of the target user, the first screen and the second screen may be obtained through screen splitting, so a display screen corresponding to the client include the first screen and the second screen. The first screen corresponds to the first cloud desktop and is configured for displaying a picture of the first cloud desktop. The second screen corresponds to the second cloud desktop and is configured for displaying a picture of the second cloud desktop.

This is equivalent to dividing a display screen of the terminal device into two operation areas: a secure operation area (i.e., first screen) and a non-secure operation area (i.e., second screen). The first cloud desktop may be operated through the first screen. The second cloud desktop may be operated through the second screen.

The sizes of the two display areas on the terminal device may be adjusted. For example, if the user is currently operating on the first screen, the size of the first screen may be enlarged, and the size of the second screen is correspondingly reduced. In response to the enlarging or reduction of the screen size, the picture of the corresponding cloud desktop displayed is also enlarged or reduced. Finally, operations on the two operation areas achieve the integration of experience, enabling the user to perform daily office work as if on a computer.

The first cloud desktop and the second cloud desktop of the target user may obtain an operation behavior triggered by the target user through the corresponding first screen or second screen, and process the operation behavior according to a security policy configured for the first cloud desktop or the second cloud desktop. In brief, if the operation behavior triggered by the user does not violate the configured security policy, it is determined that the operation behavior is valid, and the operation behavior is executed. Otherwise, if the operation behavior triggered by the user violates the configured security policy, it is determined that the operation behavior is invalid, and error prompt information is displayed on the corresponding screen.

Based on the above, in a cloudification office scenario where employees in an enterprise perform office work based on cloud desktops, a secure operation area and a non-secure operation area are set on the client side, and different levels of security policies are respectively configured for cloud desktops connected to the two operation areas, so that a user can use a same terminal to perform related operations on two connected cloud desktops based on security policies respectively configured for the cloud desktops. This not only protects data security of the enterprise, but also enables the employees in the enterprise to efficiently and flexibly complete office work.

In practical applications, a cloudification office solution previously used by an enterprise may be to assign one cloud desktop to each employee, and a resource occupied by this cloud desktop is referred to as a first resource. When the enterprise intends to use the cloudification office solution provided by the embodiments of this disclosure based on its needs without increasing the costs of the enterprise, the first resource originally occupied by one cloud desktop may be divided into two parts: a second resource and a third resource. Therefore, two cloud desktops corresponding to an employee respectively occupy the second resource and the third resource. Respective proportions of the second resource and the third resource in the first resource may be determined according to the number of applications that need to be run on each of the two cloud desktops and/or a difference between resources required by the two cloud desktops.

It should be noted that in the embodiments of this disclosure, the case where two cloud desktops are assigned to each user in the target user set and different security policies are configured for the two cloud desktops is described by way of example only. In fact, if more security policies need to be configured according to actual needs of the enterprise, more cloud desktops may be created for each user, with different security policies being configured for different cloud desktops. In addition, the user set is not limited to enterprise users.

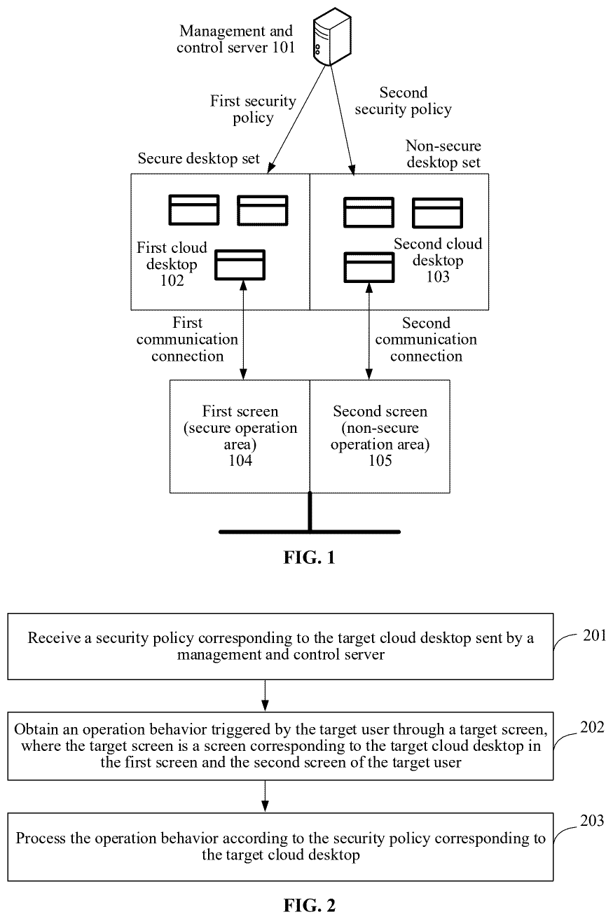

FIG. 2 is a flowchart of a cloud desktop security management and control method according to an embodiment of this disclosure. The method may be performed by a target cloud desktop corresponding to a target user in the target user set. The target cloud desktop is a first cloud desktop and a second cloud desktop corresponding to the target user. As shown in FIG. 2, the method includes the following steps. 201: Receive a security policy corresponding to the target cloud desktop sent by a management and control server. 202. Obtain an operation behavior triggered by the target user through a target screen, where the target screen is a screen corresponding to the target cloud desktop in the first screen and the second screen of the target user. 203. Process the operation behavior according to the security policy corresponding to the target cloud desktop.

As described above, each cloud desktop in the secure desktop set is deployed in the first local area network, the secure desktop set is mainly to provide a secure office environment, and cloud desktops in the office environment are all secure cloud desktops each configured with a first security policy. In summary, the first security policy has the following characteristics: having no ability to connect to an external network, i.e., being not allowed to access an external network; being not allowed to access or be accessed by secure cloud desktops of other users in the same desktop set; being allowed to only receive data, and not allowed to send data out, i.e., a non-secure cloud desktop (where cloud desktops in the non-secure desktop set are referred to as non-secure cloud desktops) of a user is allowed to copy data to a secure cloud desktop of the user, but the secure cloud desktop is not allowed to copy data to the non-secure cloud desktop.

The first two characteristics belong to network security policies, and the third characteristic belongs to a data copy security policy.

To implement the first security policy described above, in terms of physical deployment, corresponding network settings are made. For example, in a case where the secure desktop set is set in the first local area network, an external network access interface of the first local area network is configured to be disabled; a firewall is set up between different secure cloud desktops to prevent the different secure cloud desktops from accessing each other; and the local area network where the secure desktop set is located and the local area network where the non-secure desktop set is located are physically not in communication with each other.

Based on this, assuming that the target cloud desktop of the target user in the above step is a first cloud desktop located in the secure desktop set, i.e., the first cloud desktop is a secure cloud desktop, the configured first security policy includes at least one of:
the first cloud desktop corresponding to the target user is not allowed to access an external network; the first cloud desktop corresponding to the target user is not allowed to access or be accessed by a cloud desktop corresponding to another user in the first local area network (i.e., in the secure desktop set); and data generated by the first cloud desktop corresponding to the target user is not allowed to be copied to the second cloud desktop corresponding to the target user. The second cloud desktop is located in the non-secure desktop set.

Each cloud desktop in the non-secure desktop set is deployed in the second local area network, the non-secure desktop set is mainly to provide a relaxed and flexible office environment, and cloud desktops in the office environment are all non-secure cloud desktops each configured with a second security policy. In summary, the second security policy has the following characteristics: having an ability to connect to an external network, i.e., being allowed to access an external network; being allowed to access or be accessed by non-secure cloud desktops of other users in the same desktop set; being allowed to receive and send out data, i.e., a non-secure cloud desktop of a user is allowed to copy data to a secure cloud desktop of the user, and a non-secure cloud desktop of one user is also allowed to transmit data to a non-secure cloud desktop of another user.

Based on this, assuming that the target cloud desktop of the target user in the above step is a second cloud desktop located in the non-secure desktop set, i.e., the second cloud desktop is a non-secure cloud desktop, the configured second security policy includes at least one of: the second cloud desktop corresponding to the target user is allowed to access an external network; the second cloud desktop corresponding to the target user is allowed to access or be accessed by a cloud desktop corresponding to another user in the second local area network (i.e., in the non-secure desktop set); and data generated by the second cloud desktop corresponding to the target user is allowed to be copied to the first cloud desktop corresponding to the target user.

The contents of the first security policy and the second security policy described above are merely examples, and this disclosure is not limited thereto.

Processing of the operation behavior triggered by the target user when the target cloud desktop is the first cloud desktop and when the target cloud desktop is the second cloud desktop will be respectively described below.

When the target cloud desktop is the first cloud desktop corresponding to the target user, the first screen corresponding to the first cloud desktop is an area through which the target user operates the first cloud desktop.

When the user-triggered operation behavior received by the first cloud desktop is a data access operation triggered by the target user on the first screen, it is determined, according to a to-be-accessed communication address included in the data access operation and the first security policy, whether the data access operation is invalid. If the data access operation is invalid, error prompt information is output through the first screen. If the data access operation is valid, the data access operation is performed.

The data access operation may be an operation of accessing an external network by the target user, or may be an operation of accessing a cloud desktop of another user.

After receiving the data access operation, the first cloud desktop determines, according to the first security policy configured for the first cloud desktop, whether the data access operation is valid, i.e., whether the corresponding to-be-accessed communication address is allowed to be accessed. In an implementation, the first cloud desktop may perform a ping process on the to-be-accessed communication address, determine that the data access operation is valid if the to-be-accessed communication address can be pinged, and determine that the data access operation is invalid if the ping fails.

The data access operation is, for example, an operation triggered by the target user to open a browser to access a web page in the picture of the first cloud desktop displayed on the first screen, an operation triggered by the target user to input a communication address corresponding to a cloud desktop into an access address input box in the picture of the first cloud desktop displayed on the first screen, or an operation triggered by the target user to transmit data to a web disk in the picture of the first cloud desktop displayed on the first screen. All of these operations trigger the client to send the data access operation input by the target user on the first screen to the corresponding first cloud desktop. The data access operation includes a to-be-accessed communication address. For example, in the above example, the to-be-accessed communication address includes: a URL address of a web page, an IP address and a user ID that correspond to a cloud desktop, and a URL address corresponding to a network disk.

For example, the target user opens a browser on the first screen and triggers an operation of accessing a web page, and after the data access operation is obtained by the first cloud desktop, the first cloud desktop determines, based on the configuration content of “being not allowed to access an external network” in the first security policy, that the web page is not allowed to be accessed, and displays error prompt information, e.g., “this web page cannot be accessed”, through the first screen. In fact, because the external network access interface of the first local area network where the first cloud desktop is located is disabled, the address of this web page cannot be pinged.

For another example, the target user inputs an IP address corresponding to a cloud desktop of a user A on the first screen, and after the data access operation is obtained by the first cloud desktop, the first cloud desktop determines, based on the configuration content of “being not allowed to access or be accessed by secure cloud desktops of other users in the same desktop set, and being allowed to only receive data, and not allowed to send data out” in the first security policy, that the data access operation is invalid, and displays error prompt information, such as “the cloud desktop cannot be accessed”, through the first screen. The user A is the same as or different from the target user.

In fact, if the cloud desktop of the user A is a secure cloud desktop, i.e., a cloud desktop belonging to the same desktop set (i.e., located in the same local area network) as the first cloud desktop, different secure cloud desktops cannot access each other due to a firewall configuration result between the different secure cloud desktops, and therefore the data access operation is determined to be invalid. If the cloud desktop of the user A is a non-secure cloud desktop, i.e., a cloud desktop belonging to a different desktop set (i.e., located in another local area network) from the first cloud desktop, the data access operation is determined to be invalid because the two local area networks are physically not in communication with each other, i.e., the cloud desktop is not allowed to access an external network.

In addition to the above data access operations, the following data access operation triggered by the target user on the first screen may also exist: a data copy operation triggered by the target user in sequence on the first screen and the second screen. This data access operation means that the target user intends to copy data in the first cloud desktop corresponding to the target user to the second cloud desktop corresponding to the target user. In this case, due to the configuration content of “being allowed to only receive data, and not allowed to send data out, i.e., a secure cloud desktop of a user is not allowed to copy data to a non-secure cloud desktop of the user” in the first security policy, it is determined that the data copy operation is invalid, and error prompt information, e.g., “data copying is not allowed”, is output through the first screen.

Based on the data copy security policy that “a secure cloud desktop of a user is not allowed to copy data to a non-secure cloud desktop of the user”, data in the secure cloud desktop can be prevented from being transmitted from the secure office environment to a non-secure office environment.

In an embodiment of this disclosure, a manner of triggering the data copy operation is defined, including: performing a drag-and-drop operation on the to-be-copied data between the first screen and the second screen of the target user, so that a more convenient and fast data copy operation can be realized.

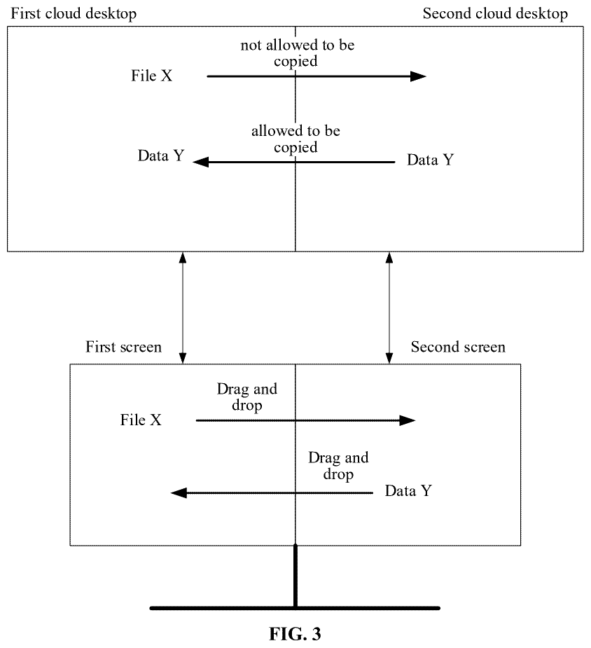

As shown in FIG. 3, on the terminal device of the target user, the first screen corresponding to the first cloud desktop is on the left side, the second screen corresponding to the second cloud desktop is on the right side, a file X displayed on the first screen is to-be-copied data, and the target user may select the file X and drag the file X from the first screen to the second screen, to trigger a data copy operation of copying the file X from the first cloud desktop to the second cloud desktop.

In fact, since the first cloud desktop and the second cloud desktop are located in different local area networks, although the data copy operation may be determined to be invalid based on the configuration content of “being not allowed to access an external network” in the first security policy, for this type of data copy operation, in an implementation, the data copy operation may also be determined to be invalid based on the data copy security policy of “a secure cloud desktop of a user is not allowed to copy data to a non-secure cloud desktop of the user” according to the following judgment idea: after receiving data copy operation information sent by the client, the first cloud desktop determines, based on that the data copy operation information indicates a data copy operation triggered by a drag behavior from the first screen to the second screen, that the data copy operation is invalid.

The above describes the processing of the operation behavior triggered by the user through the first screen when the target cloud desktop is the first cloud desktop of the target user configured with the first security policy.

Processing of the operation behavior triggered by the user through the second screen when the target cloud desktop is the second cloud desktop of the target user configured with the second security policy will be described below.

When the target cloud desktop is the second cloud desktop corresponding to the target user, the second screen corresponding to the second cloud desktop is an area through which the target user operates the second cloud desktop.

When the user-triggered operation behavior received by the second cloud desktop is a data access operation triggered by the target user on the second screen, and it is determined, according to a to-be-accessed communication address included in the data access operation and the second security policy, that the data access operation is valid, corresponding data access processing is performed on the to-be-accessed communication address. If the data access operation is invalid, error prompt information is output through the second screen.

The manner in which the target user triggers the data access operation on the second screen is similar to the manner in which the data access operation is triggered on the first screen, so the details will not be described herein again.

Due to the configuration content of “being allowed to access an external network; being allowed to access or be accessed by non-secure cloud desktops of other users in the same desktop set” in the second security policy, the data access operation triggered by the target user can be executed normally, thereby facilitating the normal office needs of the target user.

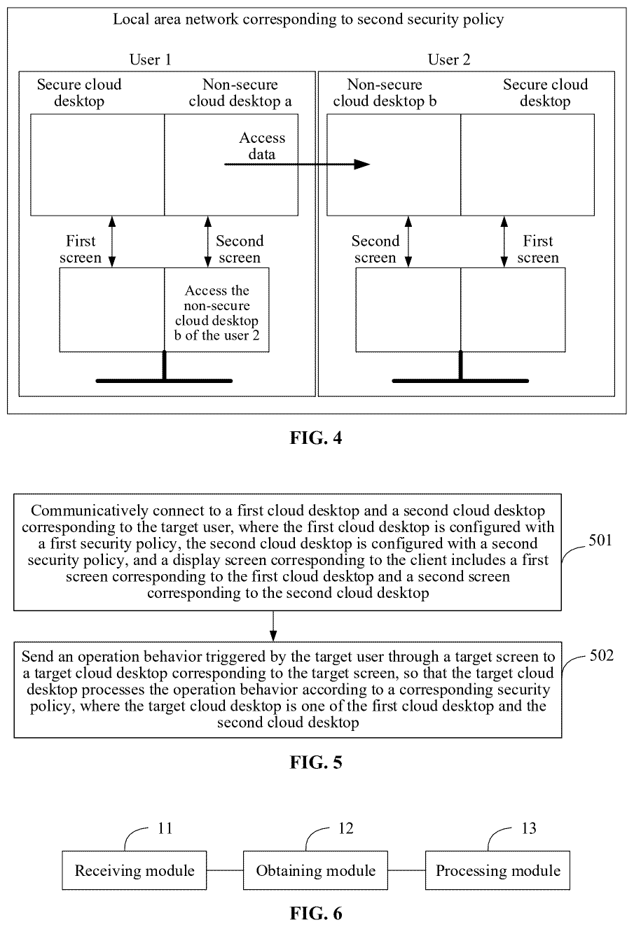

Different from the first security policy where different secure cloud desktops in the same secure desktop set are not allowed to access each other, in the second security policy, different non-secure cloud desktops in the non-secure desktop set are allowed to access each other, thereby satisfying the requirement that different users need to share some data while working. For example, as shown in FIG. 4, a non-secure cloud desktop a of a user 1 and a non-secure cloud desktop b of a user 2 are allowed to transmit access data to each other, because the two non-secure cloud desktops are located in the same local area network and are not isolated by a firewall, and therefore can ping the communication address of each other.

When the operation behavior received by the second cloud desktop is a data copy operation sequentially triggered by the target user on the second screen and the first screen, it is determined according to the second security policy that the data copy operation is valid, and to-be-copied data corresponding to the data copy operation is sent to the first cloud desktop corresponding to the target user.

In other words, the target user can access an external network through the second cloud desktop to obtain required data Y. Then, the target user can trigger a data copy operation by dragging the data Y from the second screen to the first screen. When receiving the data copy operation, the second cloud desktop determines that the dragging behavior from the second screen to the first screen is valid, and therefore copies the data Y to the first cloud desktop. It should be noted that in practical applications, the transmission of the to-be-copied data is not directly performed between the second cloud desktop and the first cloud desktop because the local area networks to which the two respectively belong are physically isolated, and for example, the to-be-copied data may be forwarded through a management and control server.

Based on the above, in a cloudification office scenario where employees in an enterprise perform office work based on cloud desktops, two screen operation areas, namely, a secure operation area and a non-secure operation area, are defined on the terminal side, and different levels of security policies are respectively defined for cloud desktops connected to the two operation areas. In addition, the two operation areas are integrated in terms of terminal experience. This not only protects data security of the enterprise, but also enables the employees in the enterprise to efficiently and flexibly complete office work.

FIG. 5 is a flowchart of a cloud desktop security management and control method according to an embodiment of this disclosure. The method may be performed by the same client communicatively connected to the first cloud desktop and the second cloud desktop of the target user. As shown in FIG. 5, the method may include the following steps. 501: Communicatively connect to a first cloud desktop and a second cloud desktop corresponding to the target user, where the first cloud desktop is configured with a first security policy, the second cloud desktop is configured with a second security policy, and a display screen corresponding to the client includes a first screen corresponding to the first cloud desktop and a second screen corresponding to the second cloud desktop. 502. Send an operation behavior triggered by the target user through a target screen to a target cloud desktop corresponding to the target screen, so that the target cloud desktop processes the operation behavior according to a corresponding security policy, where the target cloud desktop is one of the first cloud desktop and the second cloud desktop.

For operation behaviors that the target user can trigger on the target screen, reference can be made to the related description in the above other embodiments, and the details will not be described herein again.

A cloud desktop security management and control apparatus of one or more embodiments of this disclosure will be described in detail below. It can be understood by a person skilled in the art that these apparatus can be constructed from commercially available hardware components according to the steps described in the solution of this disclosure.

FIG. 6 is a schematic structural diagram of a cloud desktop security management and control apparatus according to an embodiment of this disclosure. The apparatus is located in a target cloud desktop corresponding to a target user. The target cloud desktop is one of a first cloud desktop and a second cloud desktop assigned to the target user. The first cloud desktop and the second cloud desktop corresponding to the target user are respectively communicatively connected to a same client of the target user. A display screen corresponding to the client includes a first screen corresponding to the first cloud desktop and a second screen corresponding to the second cloud desktop. As shown in FIG. 6, the apparatus includes a receiving module 11, an obtaining module 12, and a processing module 13.

The receiving module 11 is configured to receive a security policy corresponding to the target cloud desktop sent by a management and control server, where the first cloud desktop is configured with a first security policy and the second cloud desktop is configured with a second security policy.

The obtaining module 12 is configured to obtain an operation behavior triggered by the target user through a target screen, where the target screen is a screen corresponding to the target cloud desktop in the first screen and the second screen.

The processing module 13 is configured to process the operation behavior according to the security policy corresponding to the target cloud desktop.

In an implementation, the target user is any user in a target user set, the target user set is configured with a first local area network and a second local area network isolated from each other, the first cloud desktop corresponding to the target user is located in the first local area network, and the second cloud desktop corresponding to the target user is located in the second local area network.

In an implementation, the first security policy includes at least one of: the first cloud desktop corresponding to the target user is not allowed to access an external network; the first cloud desktop corresponding to the target user is not allowed to access or be accessed by a cloud desktop corresponding to another user in the first local area network; or data generated by the first cloud desktop corresponding to the target user is not allowed to be copied to the second cloud desktop corresponding to the target user. The second security policy includes at least one of: the second cloud desktop corresponding to the target user is allowed to access an external network; the second cloud desktop corresponding to the target user is allowed to access or be accessed by a cloud desktop corresponding to another user in the second local area network; or data generated by the second cloud desktop corresponding to the target user is allowed to be copied to the first cloud desktop corresponding to the target user.

In an implementation, the target cloud desktop is the first cloud desktop corresponding to the target user, and the target screen is the first screen; and the processing module 13 is specifically configured to: if the operation behavior is a data access operation triggered by the target user on the first screen, output error prompt information through the first screen when it is determined, according to a to-be-accessed communication address included in the data access operation and the first security policy, that the data access operation is invalid; and if the operation behavior is a data copy operation sequentially triggered by the target user on the first screen and the second screen, output error prompt information through the first screen when it is determined, according to the first security policy, that the data copy operation is invalid.

In an implementation, the target cloud desktop is the second cloud desktop corresponding to the target user, and the target screen is the second screen; and the processing module 13 is specifically configured to: if the operation behavior is a data access operation triggered by the target user on the second screen, perform corresponding data access processing on the to-be-accessed communication address when it is determined, according to a to-be-accessed communication address included in the data access operation and the second security policy, that the data access operation is valid; and if the operation behavior is a data copy operation sequentially triggered by the target user on the second screen and the first screen, send to-be-copied data corresponding to the data copy operation to the first cloud desktop corresponding to the target user when it is determined, according to the second security policy, that the data copy operation is valid.

In an implementation, a manner of triggering the data copy operation includes: performing a drag-and-drop operation on the to-be-copied data between the first screen and the second screen of the target user.

In an implementation, the first screen and the second screen of the target user are screens obtained by screen splitting in a same terminal device of the target user, and the client is running in the terminal device.

The apparatus shown in FIG. 6 can perform the steps executed by the target cloud desktop in the above embodiments. For detailed execution processes and technical effects, reference can be made to the description in the above embodiments, and the details will not be repeated herein.

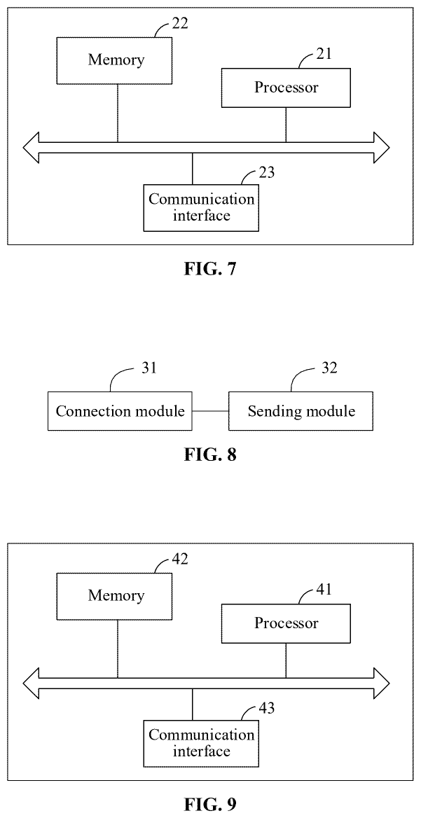

In a possible design, the structure of the cloud desktop security management and control apparatus shown in FIG. 6 may be embodied as an electronic device. As shown in FIG. 7, the electronic device may include a processor 21, a memory 22, and a communication interface 23. The memory 22 has executable codes stored therein. The executable codes, when executed by the processor 21, cause the processor 21 to at least implement the cloud desktop security management and control method executed by the target cloud desktop in the above embodiments. The electronic device may be a virtual machine in a cloud.

FIG. 8 is a schematic structural diagram of a cloud desktop security management and control apparatus according to an embodiment of this disclosure. The apparatus is located in a client corresponding to a target user. As shown in FIG. 8, the apparatus includes a connection module 31 and a sending module 32.

The connection module 31 is configured to communicatively connect to a first cloud desktop and a second cloud desktop corresponding to the target user, where the first cloud desktop is configured with a first security policy, the second cloud desktop is configured with a second security policy, and a display screen corresponding to the client includes a first screen corresponding to the first cloud desktop and a second screen corresponding to the second cloud desktop.

The sending module 32 is configured to send an operation behavior triggered by the target user through a target screen to a target cloud desktop corresponding to the target screen, so that the target cloud desktop processes the operation behavior according to a corresponding security policy, where the target cloud desktop is one of the first cloud desktop and the second cloud desktop.

The apparatus shown in FIG. 8 can perform the steps executed by the client in the above embodiments. For detailed execution processes and technical effects, reference can be made to the description in the above embodiments, and the details will not be repeated herein.

In a possible design, the structure of the cloud desktop security management and control apparatus shown in FIG. 8 may be embodied as an electronic device. As shown in FIG. 9, the electronic device may include a processor 41, a memory 42, and a communication interface 43. The memory 42 has executable codes stored therein. The executable codes, when executed by the processor 41, cause the processor 41 to at least implement the cloud desktop security management and control method executed by the client in the above embodiments. The electronic device may be a user terminal.

In the solutions provided by the embodiments of this disclosure, for example, a plurality of employees in an enterprise constitute a target user set. When cloud desktops are assigned to each user in the target user set, each target user in the target user set may be assigned two different cloud desktops: a first cloud desktop and a second cloud desktop, the first cloud desktop is configured with a first security policy, and the second cloud desktop is configured with a second security policy. To enable the target user to use the two assigned cloud desktops, a display screen corresponding to the client needs to be split into a first screen corresponding to the first cloud desktop and a second screen corresponding to the second cloud desktop, and operation behaviors of the target user on the first screen and the second screen need to be restricted by the security policies of the corresponding cloud desktops. In practical applications, the first security policy may be a security policy which is set to ensure data security, and the second security policy may be a security policy which is set to satisfy a need of the user for efficient office work. This solution not only protects data security, but also enables a user to efficiently and flexibly complete office work.

In addition, an embodiment of this disclosure provides a non-transitory machine-readable storage medium, having executable codes stored therein. The executable codes, when executed by a processor of an electronic device, cause the processor to perform the cloud desktop security management and control method provided in the above embodiments.

The apparatus embodiments described above are merely examples. The units described as separate components may or may not be physically separated. Some or all of the modules may be selected according to actual needs to achieve the objectives of the solution of this embodiment. A person of ordinary skill in the art may understand and implement the method without any creative effort.

Based on the description of the above implementations, a person skilled in the art may clearly understand that the implementations may be implemented by a necessary general hardware platform or by a combination of software and hardware. Based on such an understanding, the technical solutions essentially or the part contributing to the prior art may be embodied in the form of a computer product. This disclosure may be in the form of a computer program product implemented on one or more computer-usable storage media (including, but not limited to, a magnetic disk memory, a CD-ROM, an optical memory, and the like) containing computer-usable program codes.

Finally, it should be noted that, the foregoing embodiments are merely intended for describing the technical solutions of this disclosure, but not for limiting this disclosure. It should be understood by a person of ordinary skill in the art that although this disclosure has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the spirit and scope of the technical solutions of the embodiments of this disclosure.

1. A cloud desktop security management and control method, applied to a target cloud desktop corresponding to a target user, wherein the target cloud desktop is one of a first cloud desktop and a second cloud desktop assigned to the target user, the first cloud desktop and the second cloud desktop corresponding to the target user are respectively communicatively connected to a same client of the target user, and a display screen corresponding to the client comprises a first screen corresponding to the first cloud desktop and a second screen corresponding to the second cloud desktop,
the method comprising:
obtaining an operation behavior triggered by the target user through a target screen, wherein the target screen is a screen corresponding to the target cloud desktop in the first screen and the second screen; and
responding to the operation behavior according to a security policy corresponding to the target cloud desktop;
wherein the security policy is sent by a management and control server to the target cloud desktop, the security policy corresponding to the first cloud desktop serving as the target cloud desktop is a first security policy, and the security policy corresponding to the second cloud desktop serving as the target cloud desktop is a second security policy.

2. The method according to claim 1, wherein the target user is any user in a target user set, the target user set is configured with a first local area network and a second local area network isolated from each other, the first cloud desktop corresponding to the target user is located in the first local area network, and the second cloud desktop corresponding to the target user is located in the second local area network.

3. The method according to claim 2, wherein the first security policy comprises at least one of:
the first cloud desktop corresponding to the target user is not allowed to access an external network; the first cloud desktop corresponding to the target user is not allowed to access or be accessed by a cloud desktop corresponding to another user in the first local area network; or data generated by the first cloud desktop corresponding to the target user is not allowed to be copied to the second cloud desktop corresponding to the target user; and
the second security policy comprises at least one of:
the second cloud desktop corresponding to the target user is allowed to access an external network; the second cloud desktop corresponding to the target user is allowed to access or be accessed by a cloud desktop corresponding to another user in the second local area network; or data generated by the second cloud desktop corresponding to the target user is allowed to be copied to the first cloud desktop corresponding to the target user.

4. The method according to claim 3, wherein the target cloud desktop is the first cloud desktop corresponding to the target user, and the target screen is the first screen; and
the responding to the operation behavior according to the security policy corresponding to the target cloud desktop comprises:
in response to the operation behavior being a data access operation triggered by the target user on the first screen, outputting error prompt information through the first screen when it is determined, according to a to-be-accessed communication address specified by the data access operation and the first security policy, that the data access operation is invalid; and
in response to the operation behavior being a data copy operation from the second screen to the first screen triggered by the target user on the first screen, outputting error prompt information through the first screen when it is determined, according to the first security policy, that the data copy operation is invalid.

5. The method according to claim 3, wherein the target cloud desktop is the second cloud desktop corresponding to the target user, and the target screen is the second screen; and
the responding to the operation behavior according to the security policy corresponding to the target cloud desktop comprises:
in response to the operation behavior being a data access operation triggered by the target user on the second screen, performing corresponding data access processing on the to-be-accessed communication address when it is determined, according to a to-be-accessed communication address specified by the data access operation and the second security policy, that the data access operation is valid; and
in response to the operation behavior being a data copy operation from the second screen to the first screen triggered by the target user on the second screen, sending to-be-copied data corresponding to the data copy operation to the first cloud desktop corresponding to the target user when it is determined, according to the second security policy, that the data copy operation is valid.

6. The method according to claim 4, wherein a manner of triggering the data copy operation comprises: performing a drag-and-drop operation on to-be-copied data between the first screen and the second screen of the target user.

7. The method according to claim 1, wherein the first screen and the second screen of the target user are screens obtained by screen splitting in a same terminal device of the target user, and the client is running in the terminal device.

8. A cloud desktop security management and control method, applied to a client corresponding to a target user, the method comprising:
obtaining an operation behavior triggered by the target user through a target screen, wherein the client is communicatively connected to a first cloud desktop and a second cloud desktop corresponding to the target user, the first cloud desktop is configured with a first security policy, the second cloud desktop is configured with a second security policy, a display screen corresponding to the client comprises a first screen corresponding to the first cloud desktop and a second screen corresponding to the second cloud desktop, and the target screen is one of the first screen and the second screen; and
sending the operation behavior to a target cloud desktop corresponding to the target screen, so that the target cloud desktop responds to the operation behavior according to a corresponding security policy.

9. An electronic device, comprising: a memory, a processor, and a communication interface, wherein the memory has executable codes stored therein, and the executable codes, when executed by the processor, cause the processor to perform the cloud desktop security management and control method according to claim 1.

10. A non-transitory machine-readable storage medium, having executable codes stored therein, wherein the executable codes, when executed by a processor of an electronic device, cause the processor to perform the cloud desktop security management and control method according to claim 1.

11. A cloud desktop security management and control system, comprising:
a management and control server, configured to configure a first cloud desktop and a second cloud desktop for a target user, configure a first security policy for the first cloud desktop, and configure a second security policy for the second cloud desktop;
a client, respectively communicatively connected to the first cloud desktop and the second cloud desktop corresponding to the target user, wherein a display screen corresponding to the client comprises a first screen corresponding to the first cloud desktop and a second screen corresponding to the second cloud desktop; and
a target cloud desktop corresponding to the target user, configured to obtain an operation behavior triggered by the target user through a target screen, and respond to the operation behavior according to a security policy corresponding to the target cloud desktop, wherein the target cloud desktop is one of the first cloud desktop and the second cloud desktop corresponding to the target user, and the target screen is a screen corresponding to the target cloud desktop in the first screen and the second screen.

12. An electronic device, comprising: a memory, a processor, and a communication interface, wherein the memory has executable codes stored therein, and the executable codes, when executed by the processor, cause the processor to perform the cloud desktop security management and control method according to claim 8.

13. A non-transitory machine-readable storage medium, having executable codes stored therein, wherein the executable codes, when executed by a processor of an electronic device, cause the processor to perform the cloud desktop security management and control method according to claim 8.

14. The electronic device according to claim 9, wherein the target user is any user in a target user set, the target user set is configured with a first local area network and a second local area network isolated from each other, the first cloud desktop corresponding to the target user is located in the first local area network, and the second cloud desktop corresponding to the target user is located in the second local area network.

15. The electronic device according to claim 14, wherein the first security policy comprises at least one of:
the first cloud desktop corresponding to the target user is not allowed to access an external network; the first cloud desktop corresponding to the target user is not allowed to access or be accessed by a cloud desktop corresponding to another user in the first local area network; or data generated by the first cloud desktop corresponding to the target user is not allowed to be copied to the second cloud desktop corresponding to the target user; and
the second security policy comprises at least one of:
the second cloud desktop corresponding to the target user is allowed to access an external network; the second cloud desktop corresponding to the target user is allowed to access or be accessed by a cloud desktop corresponding to another user in the second local area network; or data generated by the second cloud desktop corresponding to the target user is allowed to be copied to the first cloud desktop corresponding to the target user.

16. The electronic device according to claim 15, wherein the target cloud desktop is the first cloud desktop corresponding to the target user, and the target screen is the first screen; and
the responding to the operation behavior according to the security policy corresponding to the target cloud desktop comprises:
in response to the operation behavior being a data access operation triggered by the target user on the first screen, outputting error prompt information through the first screen when it is determined, according to a to-be-accessed communication address specified by the data access operation and the first security policy, that the data access operation is invalid; and
in response to the operation behavior being a data copy operation from the second screen to the first screen triggered by the target user on the first screen, outputting error prompt information through the first screen when it is determined, according to the first security policy, that the data copy operation is invalid.

17. The electronic device according to claim 15, wherein the target cloud desktop is the second cloud desktop corresponding to the target user, and the target screen is the second screen; and
the responding to the operation behavior according to the security policy corresponding to the target cloud desktop comprises:
in response to the operation behavior being a data access operation triggered by the target user on the second screen, performing corresponding data access processing on the to-be-accessed communication address when it is determined, according to a to-be-accessed communication address specified by the data access operation and the second security policy, that the data access operation is valid; and
in response to the operation behavior being a data copy operation from the second screen to the first screen triggered by the target user on the second screen, sending to-be-copied data corresponding to the data copy operation to the first cloud desktop corresponding to the target user when it is determined, according to the second security policy, that the data copy operation is valid.

18. The electronic device according to claim 16, wherein a manner of triggering the data copy operation comprises: performing a drag-and-drop operation on to-be-copied data between the first screen and the second screen of the target user.

19. The electronic device according to claim 9, wherein the first screen and the second screen of the target user are screens obtained by screen splitting in a same terminal device of the target user, and the client is running in the terminal device.

20. The non-transitory machine-readable storage medium according to claim 10, wherein the target user is any user in a target user set, the target user set is configured with a first local area network and a second local area network isolated from each other, the first cloud desktop corresponding to the target user is located in the first local area network, and the second cloud desktop corresponding to the target user is located in the second local area network.
